(19) United States
(12) Patent Application Publication
(10) Pub. No.: US 2023/0146950 A1
(43) Pub. Date: May 11, 2023

(54) DETERMINISTIC LATERAL DISPLACEMENT ARRAY WITH A SINGLE COLUMN OF BUMPING OBSTACLES

(71) Applicants: Weibin LIANG, Princeton, NJ (US); James C. STURM, Princeton, NJ (US); Trustees of Princeton University, Princeton, NJ (US)

(72) Inventors: Weibin LIANG, Princeton, NJ (US); James C. STURM, Princeton, NJ (US)

(21) Appl. No.: 17/907,523

(22) PCT Filed: Apr. 1, 2021
(86) PCT No.: PCT/US21/25407

§ 371 Date: Sep. 27, 2022

Related U.S. Application Data
(60) Provisional application No. 63/004,135, filed on Apr. 2, 2020.
(60) Provisional application No. 63/073,903, filed on Sep. 2, 2020.

(51) Int. Cl. B01L 3/00

(52) U.S. Cl. CPC B01L 3/502761; B01L 2200/027; B01L 2200/0652; B01L 2300/0864; B01L 2400/086

(57) ABSTRACT

Provided are microfluidic sorting devices comprising: a sample inlet, a single column comprising a plurality of bumping features configured for lateral displacement situated in a microfluidic channel, and a plurality of outlets, wherein the single column creates a main channel and a secondary channel in the microfluidic channel, wherein the sample inlet, the plurality of outlets, and the main channel and secondary channel are in fluid connection.

### CROSS REFERENCE TO RELATED APPLICATIONS

The present application claims the benefit of U.S. provisional application 63/004,135, filed on Apr. 2, 2020 and of U.S. provisional application 63/073,903, filed on Sep. 2, 2020. The content of these previous applications is hereby incorporated by reference in its entirety.

### STATEMENT AS TO FEDERALLY SPONSORED RESEARCH

This invention was made with government support under Grant #R42CA228616-02 awarded by the National Institutes of Health. The government has certain rights in the invention.

### BACKGROUND

Cell separation for clinical applications, such as T cell harvesting for gene therapy, requires high-throughput and a compact design for low cost. A partial list of microfluidic technologies for separating particles in the 1-10 μm range includes pinched flow, inertial focusing, hydrodynamic filtration, and surface affinity.

Deterministic lateral displacement (DLD) is a microfluidic separation method that appears to be especially well suited for preparing cells for therapeutic uses. Conventionally, DLD is a size based technique that relies on flow segmentation to achieve separation. A particle-containing fluid, confined by walls, flows vertically through an array of obstacles, whose vertical axis is “tilted” with respect to the macroscopic average flow direction. Small particles flow along a streamtube towards a small-particle collection outlet, whereas particles larger than a critical diameter “bump” off successive posts from one streamtube to an adjacent one, a process that repeats at each row.

The ability of a DLD device to separate particles of different sizes may be expressed in terms of its critical diameter. The critical diameter of a conventional DLD array depends on the width of the streamtube adjacent to the bumping surface, and can be experimentally adjusted by the gap size G between the posts, and tilt angle “e”. A bulk array with posts and a mirrored layout benefits from the uniform flow within the array (except for the boundaries). This conventional design has been widely used for sorting particles and cells from 100 nm to 30 micrometers because of its stable performance.

Large particles migrate towards the collection outlet after bumping through 1/e rows of posts for each column of obstacles it has to cross (a “unit cell”). An epsilon of 1/20, implies 20 rows per column. To collect the particles that enter the top of the array at the large particle collection outlet, crossing many columns and rows is required. Further, at least half (the bottom left half) of the entire DLD array is “idle” since no large particles are bumping within this region. The designs described herein simplify and improve the throughput of these conventional DLD devices.

### SUMMARY

The present invention includes microfluidic devices that can be understood by examining FIG. 2A which shows the flow path of fluid in a single microfluidic device. The device is used for separating particles based on their size and comprises a central channel (14) connected to a sample inlet (15) at one end and to a large particle outlet (10) located distally to, and fluidically connected with the sample inlet (15). There is also a buffer channel (12) connected to a buffer inlet (13) and fluidically connected to the central channel (14) by one or more laterally oriented buffer conduits (6) (smaller channels that transfer buffer). The term “laterally oriented” as used herein means that a conduit transports fluid in a generally horizontal direction. This does not necessarily mean that the conduit forms a 90 degree angle with the channel from which it receives fluid or with the channel receiving fluid. For example, the buffer conduit may deviate from a 90 degree angle by 10 degrees, 20, 30 degrees etc. with the primary requirement being that it connect the channels so that, during operation, fluid flows from the channel of origin (e.g., the buffer channel) to the receiving channel (e.g., the central channel).

The microfluidic device also incudes a small particle channel (16), which is fluidically connected to the central channel (14) by one or more laterally oriented sample fluid conduits (7) (smaller channels that transfer fluid) and to a small particle outlet (11).

The microfluidic device shown in FIG. 2A has a single column of bumping obstacles (17), each with one or more vertices (1-5) pointing into the central channel (14). The obstacles are located at the boundary between the central channel (14) and the small particle channel (16) and have vertices that protrude into the central channel (1-5). Opposite from the obstacles (on the left side of FIG. 2A) are structural elements (18) that essentially form a column and provide walls for adjacent channels and fluid conduits. In the figure, the structural elements do not have vertices protruding into channels and are not involved in the “bumping” of particles flowing in the central channel in the same way as the bumping obstacles. The microfluidic device can have essentially any number of obstacles (for example, 2-20). Also the bumping obstacles can have a wide variety of shapes such as triangles, diamonds or other polygons.

During operation of the microfluidic device described above, buffer flows into the buffer channel (12) through the buffer inlet (13), and toward the opposite end of the buffer channel (12). A portion of the buffer flowing through the buffer channel (12) flows through each laterally oriented buffer conduit (6) and into the central channel (14). Concurrently, sample flows into the central channel (14) through the sample inlet (15) and toward a large particle outlet (10) at the opposite end of the channel (14). The microfluidic device is designed to have a specific critical size and the sample fluid comprises particles larger than the critical size and particles smaller than the critical size. As the sample fluid flows through the central channel (14), the majority of particles smaller than the critical size flow into the laterally oriented sample fluid conduits (7). There, they flow into the small particle channel (16) and then to the small particle outlet (11) where the particles may be collected as a product enriched in particles smaller than the critical size of the microfluidic device or transported elsewhere.

In contrast, the majority of particles larger than the critical size are bumped by obstacles (17) away from the laterally oriented sample fluid conduits (7) so that they remain in the central channel (14) and flow out of the large particle outlet (10). There, they may be collected as a product enriched in cells larger than the critical size of the microfluidic device or transported elsewhere. In this way particles of different sizes may be separated from one another.

In another aspect, the invention is directed to a method of separating particles in a sample using any of the microfluidic devices described above or elsewhere herein. The microfluidic device and reaction conditions should be chosen to have a critical size between the sizes of the particles being separated.

The method is performed by flowing the sample through the sample inlet (15) and into the central channel (14) where the particles in the sample flow in the direction of the large particle outlet (10). Concurrently, buffer is fed into the microfluidic device through the buffer inlet (13) where it flows into the buffer channel (12) in a direction away from the buffer inlet (13). A portion of the buffer flowing in the buffer channel (12) enters into the one or more laterally oriented buffer conduits (6) and into the central channel (14). As discussed above, the majority of particles with a size larger than the critical size of the device will remain in the central channel and eventually flow through the large particle outlet. The majority of particles with sizes smaller than the critical size of the device will flow to the small particle channel and eventually through the small particle outlet.

As noted above, particles flowing through the large particle outlet may be collected as a product enriched in particles larger than the critical size of the microfluidic device and/or fluid flowing through the small particle outlet may be collected as a product enriched in particles smaller than the critical size of the microfluidic device. Alternatively, fluid from the large particle outlet or the small particle outlet may be transported through a fluid conduit to another site where they may be analyzed, reacted, structurally altered, genetically engineered, stored, or packaged.

In a preferred embodiment, the particles larger than the critical size of the microfluidic device and the particles smaller than the critical size of the microfluidic device are both cells, with leukocytes (especially T cells) or stem cells being particularly preferred as the larger cells and platelets or erythrocytes being particularly preferred as the smaller cells. The leukocytes or stem cells and the platelets or erythrocytes may be together in a sample, with preferred samples being blood or a preparation derived from blood, such as an apheresis sample or leukapheresis sample.

The sample may be obtained from a patient having a disease or condition with the objective of obtaining cells that can be used to treat the patient. In this regard, the methods described herein can be used to separate T cells from platelets or erythrocytes. The T cells may then be expanded in culture, genetically engineered to make CAR T cells and used to treat the patient from which the sample was obtained.

More generally, the present invention is directed to a deterministic lateral displacement (DLD) device comprising a central channel and a single column of bumping obstacles configured for lateral displacement of particles in the central channel. During operation, particles smaller than the critical diameter of the device flow out of the central channel and into the small particle channel where they progress to a small particle outlet. In contrast particles larger than the critical diameter of the device are “bumped” so that they stay in the central column and flow towards a large particle outlet. Thus, the outlet towards which a particle flows is determined by its size.

The DLD device comprises a plurality of bumping obstacles which may be circular, semicircular, rectangular, triangular with top side horizontal, and triangular with bottom side horizontal shape (see e.g., FIG. 9A). As shown in FIG. 2A, the obstacles may have vertices that protrude into the central channel. The DLD device also has a buffer channel that is directly connected to a buffer inlet.

The critical diameter of the device is determined by the distance from an obstacle in the central channel and a streamline that determines flow segmentation. In addition, the ratio of a width of the small-particle outlet to a width of a buffer channel is adjusted for the critical diameter. Preferably, the critical bumping size is about equal in each row of the central column.

In another aspect, the invention is directed to a microfluidic sorting device comprising: a central channel, a small particle channel; a plurality of bumping obstacles configured for lateral displacement of particles in the central channel and a plurality of outlets, wherein the central channel, the sample inlet, the small particle channel and the plurality of outlets are fluidically connected. The sample inlet is in direct fluid connection with the central channel and the large particle outlet is directly connected to the central channel. The obstacles in the device will generally be located between the central channel and the small particle channel and the outlets present should generally include a small particle outlet in direct fluid connection with the small particle channel.

The microfluidic sorting device may have a single column of structural elements (see FIG. 2A left side for an example) which form one side of the buffer channel. These can, optionally, be configured to serve as a second column of bumping elements. Thus, in those instances, the device would have a total of two columns of bumping elements.

The bumping obstacles may be present on the left side of the central channel, the right side of the central channel or, in the case where there are two columns of bumping obstacles, on both sides.

During operation, more than about 30% (and preferably more than 40%, 60%, 80% 90% or 95%) of particles smaller than the critical size of the microfluidic device flow to the small particle outlet and more than about 30% (and preferably more than 40%, 60%, 80% 90% or 95%) of particles larger than the critical diameter value flow to the large particle outlet.

The microfluidic sorting device may have a wide range of the critical diameters. For example, a device may have a critical diameter between about 4.8 microns and about 9.9 microns. The width of any channel, column, inlet, or outlet of the device may be adjusted for the critical diameter of the device.

The microfluidic sorting device may further comprise additional channels in fluid connection to the sample inlet and end or ends of the device in order to create fluidic resistance and buffer the device from pressure fluctuations between the sample inlet and end or ends of the device. One or more additional channels may take the form of a meandering channel and fluidic resistance may be adjusted for the critical diameter value of the device.

The microfluidic sorting device may be fabricated from any material that is commonly used for microfluidic devices including silicon wafer or plastics such as polycarbonate. Pumps such as syringe pumps may be used to inject sample and/or buffer into a device. The area of one or more channels may be larger than about 0.30 square millimeters and smaller than about 0.9 square millimeters.

A plurality of the microfluidic sorting devices may be connected in series through a fluid connection of their sample inlets. The devices may be stacked in such a manner that the large particle outlet or the small particle outlet from a first device flows into the sample inlet channel of a second device and so on for the plurality of microfluidic sorting devices.

In another aspect, the invention is directed to a method of preparing target cells or target particles of a predetermined size from a sample comprising cells or particles of less or more than the predetermined size. The method involves: a) applying a sample and a wash fluid to the any of the microfluidic devices described herein, wherein the wash fluid is devoid of the target cells or target particles and devoid of cells or particles of less or more than the predetermined size; b) performing a deterministic lateral displacement by flowing the sample and wash fluid through the device; and c) collecting a final product comprising the target cells or particles from either the large particle outlet or the small particle outlet. Cells or particles obtained from an outlet of the device may also be recirculated by conveying them to an inlet of the device. This may be done to increase the concentration of cells or particles as described in WO 2019/222049, published on Nov. 21, 2019 and incorporated by reference herein in its entirety. Concentrating cells may in some instances be used to avoid, or as a substitute for, centrifugation.

Samples applied to the devices may have a variety of eukaryotic cells. Typical target cells include white blood cells; stem cells; thrombocytes; synoviocytes; fibroblasts; beta cells; liver cells; megakaryocytes; pancreatic cells; DE3 lysogenized cell; yeast cells; plant cells; algae cells; and combinations thereof. The white blood cells may comprise monocytes, T cells, B cells, regulatory T cells, central memory T cells, macrophages, dendritic cells, granulocytes, innate lymphoid cells, natural killer cells, or combinations thereof. Preferred samples are blood or preparations derived from blood such as apheresis or leukapheresis samples. The amount of sample applied to the device may be 10-100 times the amount of sample that could be processed by a DLD device of the same surface area that comprises greater than a single column comprising a plurality of bumping obstacles.

Cells obtained by the method may be used directly, stored or undergo further processing. In a preferred embodiment, target cells purified using the method are genetically engineered, e.g., to improve one or more therapeutic characteristics. In some cases, cells may be activated by contacting them with a protein or antibody and/or expanded in culture. In a particularly preferred embodiment, T cells are engineered to express chimeric antigen receptors and the resulting CAR T cells are administered to a patient.

The wash fluid used in the method may be water, an aqueous buffer or other solutions and may optionally include either: a) reagents that chemically react with the sample or other components of the wash fluid; or b) antibodies, carriers, or activators that interact with specific target cells or target particles.

Devices may be run at a flow rate of greater than about 30 microliters per minute and the throughput per area of the device may be about 54 microliters per minute per millimeter squared. The target cells or target particles may make up at least 10%, at least 20%, at least 30%, at least 40%, at least 50%, at least 60%, at least 70%, at least 80%, or at least 90% of the total cells or total particles in the final product.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present invention may be obtained by reference to the following detailed description that sets forth illustrative embodiments, in which the principles of the invention are utilized, and the accompanying drawings of which:

FIG. 1 shows a schematic of a conventional DLD array. The tilt angle (ε=d/λ) is ⅓ in this figure. The regions 1, 2 and 3 show the flow segmentation which determines the critical diameter. Small particles flow along the streamtube while the large particles bump along the posts and migrate toward the right.

FIG. 2A-C is a schematic of an example single-column DLD device. FIG. 2A shows the overall schematic of a single-column DLD device with 5 rows of bumping obstacles. The thin black lines represent streamlines. The particle-containing “Sample” fluid and a buffer without particles enter from the top. FIGS. 2B and 2C are enlarged views of particles and streamtubes at the site of obstacles. In FIG. 2A, structural elements have the following numeric identifiers:
1-5 Vertices of the obstacles in microfluidic devices. The vertices point into the central channel and are the part of obstacles primarily responsible for bumping particles flowing through the channel.
6 Buffer conduits: These are smaller channels that branch from the buffer channel. They convey buffer from the buffer channel to the center channel.
7 Sample fluid conduits. These are smaller channels that branch from the central channel to the small particle channel.
8 Particle with a size below the critical size of the microfluidic device.
9 Particle with a size larger than the critical size of the microfluidic device.
10 Large particle outlet.
11 Small particle outlet.
12 Buffer channel.
13 Buffer inlet.
14 Central channel.
15 Sample inlet.
16 Small particle channel.
17 Column of bumping obstacles with vertices (1-5) that point into the central channel.
18 Structural elements which provide walls defining the buffer channel and the left side of the central channel.

FIG. 3 shows a design of a DLD device with a single column of bumping obstacles used for experimentation. The entire device (not including the inlet/outlet ports) measures 1.5 mm long by 0.37 mm wide with a uniform channel depth of 12 μm.

FIG. 4A-4C is based on a color containing counterpart showing fluorescent images of fluid flow patterns and microparticle trajectories. The dotted lines indicate the approximate channel locations: 4A: flow pattern of buffer and sample input, exposure time: 1.3 s; 4B: 9.9-μm microparticle trajectories, exposure time 1/30s; 4C: 4.8-μm microparticle trajectories, exposure time 1/30s.

FIG. 5 shows the fraction of the input particles in the large and small particle output streams of 4.8 μm, 7.3 μm, and 9.9 μm microparticles.

FIG. 6 shows a DLD device in which the central channel outlet divides into two parts and in which the diameters of the left channel (the buffer channel of FIG. 2A) and the right channel (the small particle channel of FIG. 2A) have been adjusted along the their length.

FIG. 7 shows a channel comparable to the central channel of FIG. 2A in which there is both a buffer inlet and a sample inlet. As in FIG. 6, the width of channels has been adjusted along their length. The obstacles on the right side are rectangular with vertices that extend into the channel. However, polygons of other shapes could also be used.

FIGS. 8A and 8B show examples of other post shapes for use in a DLD device. 8A shows spherical posts. 8B shows a selection of other post shapes that may be used.

FIGS. 9A and 9B shows how obstacle or post location and shape can vary in a single channel. Additional obstacles can be added to any location of the device for any specific requirement. Any combinations of posts shape, size and location can be used for specific requirements.

FIG. 10 shows the integration of fluidic resistance to make a device immune to fluctuation in input and output pressures between the left and the right outputs.

### DETAILED DESCRIPTION

Provided herein are devices and methods useful in separating cells and particles for research tools, therapies, or other useful biological compositions. Such devices and methods may utilize a single column containing bumping features as a DLD device in order to performs separations.

### Devices

Principles of DLD and the Designing Microfluidic Plates

Cells, particularly cells in compositions prepared by apheresis or leukapheresis, and particles other than cells may be isolated by performing conventional DLD using microfluidic devices that contain a channel through which fluid flows from one or more inlets at or near one end of the device to outlets at or near the opposite end. Basic principles of size based microfluidic separations and the design of obstacle (also called “bumping features”) arrays for separating cells have been provided elsewhere (see, US 2014/0342375; US 2016/0139012; U.S. Pat. Nos. 7,318,902; 7,150,812, and PCT US 19/31738 which are hereby incorporated herein in their entirety).

Described herein are devices that differ from conventional DLD devices in that separations do not involve the tilt angle of an obstacle array, thereby allowing the size of devices to be reduced. One way of obtaining a more concentrated preparation of large particles in such devices is based on a recognition that, during DLD, large cells will tend to flow along the wall of a vertical channel on the same side as the obstacles. An outlet channel may be split into two branches (see FIG. 6), so that the left branch removes a portion of the buffer (without cells), and the right branch contains the larger cells at increased concentration compared to their average density in the outlet channel before splitting.

One way that the size of a device can be further reduced by eliminating the buffer inlet channels. The buffer and sample may be injected from the same side (for example, see FIG. 7). The amount of narrowing of the left vertical channel (or reduction in its depth) as it progresses down through the array, and the length, width, and depth of the horizontal channels carrying fluid to the small particle output channel should be designed together to keep the critical particle size at each obstacle similar. One drawback of this approach is that that the large particle outlet will have certain level of small particle contamination.

The posts (i.e., obstacles) used in DLD can have a wide variety of shapes as shown in FIGS. 8A, 8B and 9A. The obstacles may take the shape of columns or be triangular, square, rectangular, diamond shaped, trapezoidal, hexagonal, teardrop shaped, circular, semicircular, triangular with a top side horizontal shape, or triangular with a bottom side horizontal shape. In the present application obstacles with vertices are generally preferred. FIG. 9A and FIG. 9B show examples of various shapes, locations, and a possible variant of a single column DLD device.

Additional channels, such as meandering channels (see FIG. 10) may be designed into the device to add fluid resistance. Integration of fluidic resistance helps to make a device immune to fluctuation in input and output pressures between the left and right input and between left and right outputs. The separation characteristics of the device is sensitive to the pressure of inlets and outlets and, to offset negative effects, integrated fluidic resistance may be applied to each of the outlets/inputs. Other implementations may include simply narrowing the input and output channels for some distance, reducing their depth, or breaking them up into multiple parallel narrow channels.

Making and Operating Microfluidic Devices

Conventional procedures for making and using microfluidic devices that are capable of separating cells or particles on the basis of size are known in the art and can provide general background information and guidance with respect to the present invention. Microfluidic devices include those described in U.S. Pat. Nos. 5,837,115; 7,150,812; 6,685,841; 7,318,902; 7,472,794; 7,735,652; and WO/2019/222049 all of which are hereby incorporated by reference in their entirety. Other references that provide guidance that may be helpful in the making and use of devices for the present invention include: U.S. Pat. Nos. 5,427,663; 7,276,170; 6,913,697; 7,988,840; 8,021,614; 8,282,799; 8,304,230; 8,579,117; US 2006/0134599; US 2007/0160503; US 20050282293; US 2006/0121624; US 2005/0266433; US 2007/0026381; US 2007/0026414; US 2007/0026417; US 2007/0026415; US 2007/0026413; US 2007/0099207; US 2007/0196820; US 25 2007/0059680; US 2007/0059718; US 2007/005916; US 2007/0059774; US 2007/0059781; US 2007/0059719; US 2006/0223178; US 2008/0124721; US 2008/0090239; US 2008/0113358; and WO2012094642 all of which are also incorporated by reference herein in their entirety. Of the various references describing conventional ways for the making and use of devices, U.S. Pat. No. 7,150,812 provides good guidance and 7,735,652 is of particular interest with respect to microfluidic devices for separations performed on samples with cells found in blood (in this regard, see also US 2007/0160503).

A device can be made using any of the materials from which micro- and nano-scale fluid handling devices are typically fabricated, including silicon, glasses, plastics, and hybrid materials. A diverse range of thermoplastic materials suitable for microfluidic fabrication is available, offering a wide selection of mechanical and chemical properties that can be leveraged and further tailored for specific applications.

Techniques for making devices include Replica molding, Soft lithography with PDMS, Thermoset polyester, Embossing, Injection Molding, Laser Ablation and combinations thereof. Further details can be found in “Disposable microfluidic devices: fabrication, function and application” by Fiorini, et al. (BioTechniques 38:429-446 (March 2005)), which is hereby incorporated by reference herein in its entirety. The book “Lab on a Chip Technology” edited by Keith E. Herold and Avraham Rasooly, Caister Academic Press Norfolk UK (2009) is another resource for methods of fabrication, and is hereby incorporated by reference herein in its entirety.

High-throughput embossing methods such as reel-to-reel processing of thermoplastics is an attractive method for industrial microfluidic chip production. The use of single chip hot embossing can be a cost-effective technique for realizing high-quality microfluidic devices during the prototyping stage. Methods for the replication of microscale features in two thermoplastics, polymethylmethacrylate (PMMA) and/or polycarbonate (PC), are described in “Microfluidic device fabrication by thermoplastic hot-embossing” by Yang, et al. (Methods Mol. Biol. 949:115-23 (2013)), which is hereby incorporated by reference herein in its entirety.

A flow channel can be constructed using two or more pieces which, when assembled, form a closed cavity (preferably one having orifices for adding or withdrawing fluids) having the obstacles disposed within it. The obstacles can be fabricated on one or more pieces that are assembled to form the flow channel, or they can be fabricated in the form of an insert that is sandwiched between two or more pieces that define the boundaries of the flow channel.

Surfaces can be coated to modify their properties and polymeric materials employed to fabricate devices, can be modified in many ways. In some cases, functional groups such as amines or carboxylic acids that are either in the native polymer or added by means of wet chemistry or plasma treatment are used to crosslink proteins or other molecules. DNA can be attached to COC and PMMA substrates using surface amine groups. Surfactants such as 30 Pluronic® can be used to make surfaces hydrophilic and protein repellant by adding Pluronic® to PDMS formulations. In some cases, a layer of PMMA is spin coated on a device, e.g., microfluidic chip and PMMA is “doped” with hydroxypropyl cellulose to vary its contact angle.

To reduce non-specific adsorption of cells or compounds, e.g., released by lysed cells or found in biological samples, onto the channel walls, one or more walls may be chemically modified to be non-adherent or repulsive. The walls may be coated with a thin film coating (e.g., a monolayer) of commercial non-stick reagents, such as those used to form hydrogels. Additional examples of chemical species that may be used to modify the channel walls include oligoethylene glycols, fluorinated polymers, organosilanes, thiols, poly-ethylene glycol, hyaluronic acid, bovine serum albumin, poly-vinyl alcohol, mucin, poly-HEMA, methacrylated PEG, and agarose. Charged polymers such as heparin may also be employed to repel oppositely charged species. The type of chemical species used for repulsion and the method of attachment to the channel walls can depend on the nature of the species being repelled and the nature of the walls. Such surface modification techniques are well known in the art.

Separation Processes that Use DLD

The DLD devices described herein can be used to purify cells, cellular fragments, cell adducts, or nucleic acids. As discussed herein, these devices can also be used to separate a cell population of interest from a plurality of other cells.

Viable Cells

In one embodiment devices are used in procedures designed to separate a viable cell from a nonviable cell. The term “viable cell” refers to a cell that is capable of growth, is actively dividing, is capable of reproduction, or the like.

Adherent Cells

In another embodiment, DLD devices can be used to separate adherent cells. The term “adherent cell” as used herein refers to a cell capable of adhering to a surface. Adherent cells include immortalized cells used in cell culturing and can be derived from mammalian hosts. In some instances, the adherent cell may be trypsinized prior to purification. Examples of adherent cells include MRC-5 cells; HeLa cells; Vero cells; NIH 3T3 cells; L929 cells; Sf21 cells; Sf9 cells; A549 cells; A9 cells; AtT-20 cells; BALB/3T3 cells; BHK-21 cells; BHL-100 cells; BT cells; Caco-2 cells; Chang cells; Clone 9 cells; Clone M-3 cells; COS-1 cells; COS-3 cells; COS-7 cells; CRFK cells; CV-1 cells; D-17 cells; Daudi cells; GH1 cells; GH3 cells; HaK cells; HCT-10 15 cells; HL-60 cells; HT-1080 cells; HT-29 cells; HUVEC cells; 1-10 cells; IM-9 cells; JEG-2cells; Jensen cells; Jurkat cells; K-562 cells; KB cells; KG-1 cells; L2 cells; LLC-WRC 256 cells; McCoy cells; MCF7 cells; WI-38 cells; WISH cells; XC cells; Y-1 cells; CHO cells; Raw 264.7; BHK-21 cells; HEK 293 cells to include 293A, 293T and the like; HEP G2 cells; BAE-1 cells; SH-SYSY cells; and any derivative thereof to include engineered and recombinant strains.

In some embodiments, procedures may involve separating cells from a diluent such as growth media, which may provide for the efficient maintenance of a culture of the adherent cells.

For example, a culture of adherent cells in a growth medium can be exchanged into a transfection media comprising transfection reagents, into a second growth medium designed to elicit change within the adherent cell such as differentiation of a stem cell, or into sequential wash buffers designed to remove compounds from the culture.

In one procedure, adherent cells are purified through association with one or more carriers that bind in a way that promotes DLD separation. The carriers may be of the type described herein and binding may stabilize and/or activate the cells. A carrier will typically be in the rage of 1-1000 micromolar but may sometimes also be outside of this range.

The association between a carrier and a cell should produce a complex of increased size relative to other material not associated with the carrier. Depending of the particular size of the cells and carriers and the number of cells and carriers present, a complex may be anywhere from a few percent larger than the uncomplexed cell to many times the size of the uncomplexed cell. In order to facilitate separations, an increase of at least 20% is desirable with higher percentages (50; 100; 1000 or more) being preferred.

Activated Cells

DLD devices can also be used in procedures for separating an activated cell or a cell capable of activation, from a plurality of other cells. The terms “activated cell” or “cell capable of activation” refer to a cell that has been, or can be activated, respectively, through association, incubation, or contact with a cell activator. Examples of cells capable of activation can include cells that play a role in the immune or inflammatory response such as: T cells, B cells; regulatory T cells, macrophages, dendritic cells, granulocytes, innate lymphoid cells, megakaryocytes, natural killer cells, thrombocytes, synoviocytes, and the like; cells that play a role in metabolism, such as beta cells, liver cells, and pancreatic cells; recombinant cells capable of inducible protein expression such as DE3 lysogenized E. coli cells, yeast cells, plant cells, algae; and other cells such as monocytes and stem cells.

Typically, one or more carriers will have the activator on their surface. Examples of cell activators include proteins, antibodies, cytokines, CD3, CD28, antigens against a specific protein, helper T cells, receptors, and glycoproteins; hormones such as insulin, glucagon and the like; IPTG, lactose, allolactose, lipids, glycosides, terpenes, steroids, and alkaloids. The activatable cell should be at least partially associated with carriers through interaction between the activatable cell and cell activator on the surface of the carriers. The complexes formed may be just few percent larger than the uncomplexed cell or many times the size of the uncomplexed cell. In order to facilitate separations, an increase of at least 20% is desirable with higher percentages (40, 50 100 1000 or more) being preferred.

Separating Cells from Toxic Material

DLD can also be used in purifications designed to remove compounds that may be toxic to a cell or to keep the cells free from contamination by a toxic compound. The ability to separate toxic material may be important for a wide variety of cells including: bacterial strains such as BL21, Tuner, Origami, Origami B, Rosetta, C41, C43, DHSa, DH100, or XL1Blue; yeast strains such as those of genera Saccharomyces, Pichia, Kluyveromyces, Hansenula and Yarrowia; algae; and mammalian cell cultures, including cultures of MRC-5 cells; HeLa cells; Vero cells; NIH 3T3 cells; L929 cells; Sf21 cells; Sf9 cells; A549 cells; A9 cells; AtT-20 cells; BALB/3T3 cells; BHK-21 cells; BHL-100 cells; BT 10 cells; Caco-2 cells; Chang cells; Clone 9 cells; Clone M-3 cells; COS-1 cells; COS-3 cells; COS-7 cells; CRFK cells; CV-1 cells; D-17 cells; Daudi cells; GH1 cells; GH3 cells; HaK cells; HCT-15 cells; HL-60 cells; HT-1080 cells; HT-29 cells; HUVEC cells; I-10 cells; IM-9 cells; JEG-2 cells; Jensen cells; Jurkat cells; K-562 cells; KB cells; KG-1 cells; L2 cells; LLC-WRC 256 cells; McCoy cells; MCF7 cells; WI-38 cells; WISH cells; XC cells; Y-1 cells; CHO cells; Raw 15 264.7; BHK-21 cells; HEK 293 cells to include 293A, 293T and the like; HEP G2 cells; BAE-1 cells; SH-SYSY cells; stem cells and any derivative thereof to include engineered and recombinant strains.

Immune Cells

DLD can also be used in purifications designed to enrich or isolate selected immune cells from sample inputs. Samples, such as those from whole blood, apheresis or leukapheresis, can be loaded into a DLD device for such processing in order to create enriched cell populations for activation, engineering, cryopreservation, or biological analytics. Examples include T cell activation, immune cell genetic engineering via CRISPR/CRISPR Cas or other methods, and preserving cells for therapy. Other examples include combining various downstream or upstream processes from the DLD in order to create custom therapies, such as Chimeric Antigen Receptor T-cells.

The ability to isolate, enrich, and purify populations of immune cells is important for a wide variety of immune cells, including: Peripheral blood mononuclear cells (T lymphocytes, B lymphocytes, natural killer cells, and monocytes), granulocytes (neutrophils, eosinophils, basophils, and mast cells). In particular, helper T cells, memory T cells, cytotoxic T cells, regulatory T cells, natural killer T cells, gamma delta t cells, MAIT cells, B cells, memory B cells, plasma B cells, dendritic cells, macrophages, natural killer cells, neutrophils, eosinophils, platelets, and basophils may be used and recovered using DLD for upstream and downstream processes.

DLD separations may be used in conjunction with genetically engineering cells. Genetic engineering may entail contacting a cell with an exogeneous nucleic acid so that the nucleic acid is inserted into the cell. In some cases, the nucleic acid is integrated into the host cell's genome. In other cases, the nucleic acid resides in exosomes or freely within the host cell's cytoplasm. In any case, the nucleic acid alters gene expression, gene function, or epigenetic function of the host cell, not limited to transcription, translation, interference, or use as a guide nucleic acid. Some methods of inserting exogenous nucleic acid into a cell include transformation, transfection, transduction, electroporation, or chemical nanopore transportation.

DLD devices may be used as part of a process for preparing Chimeric Antigen Receptor T Cells. For example, DLD may be employed to isolate T cells for downstream engineering of a chimeric antigen receptor that combines antigen-binding and T cell activation via an intracellular CD3-zeta domain. Another process may create engineered receptors coupled to intracellular activation in a cell other than a T cell.

Technological Background

Without being held to any particular theory, a general discussion of some background technical aspects of microfluidics may help in understanding factors that affect separations carried out in this field. A variety of microfabricated sieving matrices have been disclosed for separating particles (Chou, et. al., Proc. Natl. Acad. Sci. 96:13762 (1999); Han, et al., Science 288:1026 (2000); Huang, et al., Nat. Biotechnol. 20:1048 (2002); Turner et al., Phys. Rev. Lett. 88(12):128103 (2002); Huang, et al., Phys. Rev. Lett. 89:178301 (2002); U.S. Pat. Nos. 5,427,663; 7,150,812; 6,881,317). Bump array (also known as “obstacle array”) devices have been described, and their basic operation is explained, for example in U.S. Pat. No. 7,150,812, which is incorporated herein by reference in its entirety.

Fractionation Range

Objects separated by size on microfluidic devices include cells, biomolecules, inorganic beads, and other objects. Typical sizes fractionated range from 100 nanometers to 50 micrometers. However, larger and smaller particles may also sometimes be fractionated or isolated.

In some examples, the size of the particles or cells being isolated are about 0.5 micrometers to about 5 micrometers. In some examples, the size of the particles or cells being isolated are about 0.5 micrometers to about 1 micrometer, about 0.5 micrometers to about 2.5 micrometers, about 0.5 micrometers to about 5 micrometers, about 1 micrometer to about 2.5 micrometers, about 1 micrometer to about 5 micrometers, or about 2.5 micrometers to about 5 micrometers. In some examples, the size of the particles or cells being isolated are about 0.5 micrometers, about 1 micrometer, about 2.5 micrometers, or about 5 micrometers. In some examples, the size of the particles or cells being isolated are at least about 0.5 micrometers, about 1 micrometer, or about 2.5 micrometers. In some examples, the size of the particles or cells being isolated are at most about 1 micrometer, about 2.5 micrometers, or about 5 micrometers.

In some examples, the size of the particles or cells being isolated are about 1 micrometer to about 10 micrometers. In some examples, the size of the particles or cells being isolated are about 1 micrometer to about 2.5 micrometers, about 1 micrometer to about 5 micrometers, about 1 micrometer to about 10 micrometers, about 2.5 micrometers to about 5 micrometers, about 2.5 micrometers to about 10 micrometers, or about 5 micrometers to about 10 micrometers. In some examples, the size of the particles or cells being isolated are about 1 micrometer, about 2.5 micrometers, about 5 micrometers, or about 10 micrometers. In some examples, the size of the particles or cells being isolated are at least about 1 micrometer, about 2.5 micrometers, or about 5 micrometers. In some examples, the size of the particles or cells being isolated are at most about 2.5 micrometers, about 5 micrometers, or about 10 micrometers.

In some examples, the size of the particles or cells being isolated are about 10 micrometers to about 100 micrometers. In some examples, the size of the particles or cells being isolated are about 10 micrometers to about 25 micrometers, about 10 micrometers to about 50 micrometers, about 10 micrometers to about 100 micrometers, about 25 micrometers to about 50 micrometers, about 25 micrometers to about 100 micrometers, or about 50 micrometers to about 100 micrometers. In some examples, the size of the particles or cells being isolated are about 10 micrometers, about 25 micrometers, about 50 micrometers, or about 100 micrometers. In some examples, the size of the particles or cells being isolated are at least about 10 micrometers, about 25 micrometers, or about 50 micrometers. In some examples, the size of the particles or cells being isolated are at most about 25 micrometers, about 50 micrometers, or about 100 micrometers.

After fractionation and isolation, DLD outputs may be of various purities as compared to non-targeted cells. In some examples, the percent purity of the target cells are about 2 percent to about 99 percent. In some examples, the percent purity of the target cells are about 2 percent to about 5 percent, about 2 percent to about 10 percent, about 2 percent to about 30 percent, about 2 percent to about 50 percent, about 2 percent to about 75 percent, about 2 percent to about 80 percent, about 2 percent to about 85 percent, about 2 percent to about 90 percent, about 2 percent to about 95 percent, about 2 percent to about 99 percent, about 5 percent to about 10 percent, about 5 percent to about 30 percent, about 5 percent to about 50 percent, about 5 percent to about 75 percent, about 5 percent to about 80 percent, about 5 percent to about 85 percent, about 5 percent to about 90 percent, about 5 percent to about 95 percent, about 5 percent to about 99 percent, about 10 percent to about 30 percent, about 10 percent to about 50 percent, about 10 percent to about 75 percent, about 10 percent to about 80 percent, about 10 percent to about 85 percent, about 10 percent to about 90 percent, about 10 percent to about 95 percent, about 10 percent to about 99 percent, about 30 percent to about 50 percent, about 30 percent to about 75 percent, about 30 percent to about 80 percent, about 30 percent to about 85 percent, about 30 percent to about 90 percent, about 30 percent to about 95 percent, about 30 percent to about 99 percent, about 50 percent to about 75 percent, about 50 percent to about 80 percent, about 50 percent to about 85 percent, about 50 percent to about 90 percent, about 50 percent to about 95 percent, about 50 percent to about 99 percent, about 75 percent to about 80 percent, about 75 percent to about 85 percent, about 75 percent to about 90 percent, about 75 percent to about 95 percent, about 75 percent to about 99 percent, about 80 percent to about 85 percent, about 80 percent to about 90 percent, about 80 percent to about 95 percent, about 80 percent to about 99 percent, about 85 percent to about 90 percent, about 85 percent to about 95 percent, about 85 percent to about 99 percent, about 90 percent to about 95 percent, about 90 percent to about 99 percent, or about 95 percent to about 99 percent. In some examples, the percent purity of the target cells are about 2 percent, about 5 percent, about 10 percent, about 30 percent, about 50 percent, about 75 percent, about 80 percent, about 85 percent, about 90 percent, about 95 percent, or about 99 percent. In some examples, the percent purity of the target cells are at least about 2 percent, about 5 percent, about 10 percent, about 30 percent, about 50 percent, about 75 percent, about 80 percent, about 85 percent, about 90 percent, or about 95 percent. In some examples, the percent purity of the target cells are at most about 5 percent, about 10 percent, about 30 percent, about 50 percent, about 75 percent, about 80 percent, about 85 percent, about 90 percent, about 95 percent, or about 99 percent.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

As used herein, the terms “treatment” or “treating” are used in reference to a pharmaceutical or other intervention regimen for obtaining beneficial or desired results in the recipient. Beneficial or desired results include but are not limited to a therapeutic benefit and/or a prophylactic benefit. A therapeutic benefit may refer to eradication or amelioration of symptoms or of an underlying disorder being treated. Also, a therapeutic benefit can be achieved with the eradication or amelioration of one or more of the physiological symptoms associated with the underlying disorder such that an improvement is observed in the subject, notwithstanding that the subject may still be afflicted with the underlying disorder. A prophylactic effect includes delaying, preventing, or eliminating the appearance of a disease or condition, delaying or eliminating the onset of symptoms of a disease or condition, slowing, halting, or reversing the progression of a disease or condition, or any combination thereof. For prophylactic benefit, a subject at risk of developing a particular disease, or to a subject reporting one or more of the physiological symptoms of a disease may undergo treatment, even though a diagnosis of this disease may not have been made. The skilled artisan will recognize that in a heterogeneous population different people will respond differently if at all, these individuals are considered treated.

The section headings used herein are for organizational purposes only and are not to be construed as limiting the subject matter described.

As used herein, apheresis refers to a procedure in which blood from a patient or donor is separated into its components, e.g., plasma, white blood cells and red blood cells. More specific terms are “plateletpheresis” (referring to the separation of platelets) and “leukapheresis” (referring to the separation of leukocytes). In this context, the term “separation” refers to the obtaining of a product that is enriched in a particular component compared to whole blood and does not mean that absolute purity has been attained.

The term “CAR” is an acronym for “chimeric antigen receptor.” A “CART cell” is therefore a T cell that has been genetically engineered to express a chimeric receptor.

CART cell therapy refers to any procedure in which a disease is treated with CART cells. Diseases that may be treated include hematological and solid tumor cancers, autoimmune diseases and infectious diseases.

As used herein, the term “carrier” refers an agent, e.g., a bead, or particle, made of either biological or synthetic material that is added to a preparation for the purpose of binding directly or indirectly (i.e., through one or more intermediate cells, particles or compounds) to some or all of the compounds or cells present. Carriers may be made from a variety of different materials, including DEAE-dextran, glass, polystyrene plastic, acrylamide, collagen, and alginate and will typically have a size of 1-1000 μm. They may be coated or uncoated and have surfaces that are modified to include affinity agents (e.g., antibodies, activators, haptens, aptamers, particles or other compounds) that recognize antigens or other molecules on the surface of cells. The carriers may also be magnetized and this may provide an additional means of purification to complement DLD and they may comprise particles (e.g., Janus or Strawberry-like particles) that confer upon cells or cell complexes non-size related secondary properties. For example the particles may result in chemical, electrochemical, or magnetic properties that can be used in downstream processes, such as magnetic separation, electroporation, gene transfer, and/or specific analytical chemistry processes. Particles may also cause metabolic changes in cells, activate cells or promote cell division.

Carriers that bind “in away that promotes DLD separation” refers to carriers and methods of binding carriers that affect the way that, depending on context, a cell, protein or particle behaves during DLD. This refers both to carriers that modify cells, proteins, or particles to promote separation from a given mixture, and carriers that modify cells such that the cells, proteins, or particles are not separated from a given mixture. Specifically, “binding in a way that promotes DLD separation” means that: a) the binding must exhibit specificity for a particular target cell type, protein or particle; and b) must result in a complex that provides for an increase in size of the complex relative to the unbound cell, protein or particle; or a reduction in deformability of the cell, protein, or particle (thus leading to an increase in apparent size). In the case of binding to a target cell, there must be an increase of at least 2 μm (and alternatively at least 20, 50, 100, 200, 500 or 1000% when expressed as a percentage). In cases where therapeutic or other uses require that target cells, proteins or other particles be released from complexes to fulfill their intended use, then the term “in a way that promotes DLD separation” also requires that the complexes permit such release, for example by chemical or enzymatic cleavage, chemical dissolution, digestion, due to competition with other binders, or by physical shearing (e.g., using a pipette to create shear stress) and the freed target cells, proteins or other particles must maintain activity; e.g., therapeutic cells after release from a complex must still maintain the biological activities that make them therapeutically useful.

Carriers may also bind “in a way that complements DLD separation”: This term refers to carriers and methods of binding carriers that change the chemical, electrochemical, or magnetic properties of cells or cell complexes or that change one or more biological activities of cells, regardless of whether they increase size sufficiently to promote DLD separation. Carriers that complement DLD separation also do not necessarily bind with specificity to target cells, i.e., they may have to be combined with some other agent that makes them specific or they may simply be added to a cell preparation and be allowed to bind non-specifically. The terms “in a way that complements DLD separation” and “in a way that promotes DLD separation” are not exclusive of one another. Binding may both complement DLD separation and also promote DLD separation. For example, a polysaccharide carrier may have an activator on its surface that increases the rate of cell growth and the binding of one or more of these carriers may also promote DLD separation. Alternatively, binding may promote DLD separation or complement DLD separation.

As used herein “target cells” are the cells that various procedures described herein require or are designed to purify, collect, engineer etc. What the specific cells are will depend on the context in which the term is used. For example, if the objective of a procedure is to isolate a particular kind of stem cell, that cell would be the target cell of the procedure.

Unless otherwise indicated, “isolate” or “purify”, as used herein, are synonymous and refer to the enrichment of a desired product relative to unwanted material. The terms do not necessarily mean that the product is completely isolated or completely pure. For example, if a starting sample had a target cell that constituted 2% of the cells in a sample, and a procedure was performed that resulted in a composition in which the target cell was 60% of the cells present, the procedure would have succeeded in isolating or purifying the target cell.

The terms “bump array” and “obstacle array” are used synonymously herein and describe an ordered array of obstacles that are disposed in a flow channel through which a cell or particle-bearing fluid can be passed.

As used herein, the term “Deterministic Lateral Displacement” or “DLD” refers to a process in which particles are deflected deterministically, based on their size. This process can be used to separate cells, which is generally the context in which it is discussed herein. However, it is important to recognize that DLD can also be used to concentrate cells and for buffer exchange.

The “critical size” or “predetermined size” or “critical diameter” or “critical diameter value” or “critical bumping size” of particles passing through an obstacle array describes the size limit of particles that are able to follow the laminar flow of fluid. Particles larger than the critical size can be ‘bumped’ from the flow path of the fluid while particles having sizes lower than the critical size (or predetermined size) will not necessarily be so displaced.

The terms “fluid flow” and “bulk fluid flow” as used herein in connection with DLD refer to the macroscopic movement of fluid in a general direction across an obstacle array. These terms do not take into account the temporary displacements of fluid streams for fluid to move around an obstacle in order for the fluid to continue to move in the general direction.

In a conventional bump array device, the tilt angle, or “title angle c” is the angle between the direction of bulk fluid flow and the direction defined by alignment of rows of sequential (in the direction of bulk fluid flow) obstacles in the array.

### EXAMPLES

The following examples are included for illustrative purposes only and are not intended to limit the scope of the invention. In certain places, the text refers to colors which are not present in the figures reproduced herein but were present in the original figures. A description of related experiments and figures may be found in Liang et al., “Scaling of deterministic lateral displacement devices to a single column of bumping obstacles,” Lab on a Chip 20:3461-3467 (published by the Royal Society of Chemistry, 2020), incorporated by reference herein in its entirety.

### Example 1: Conventional DLD Array

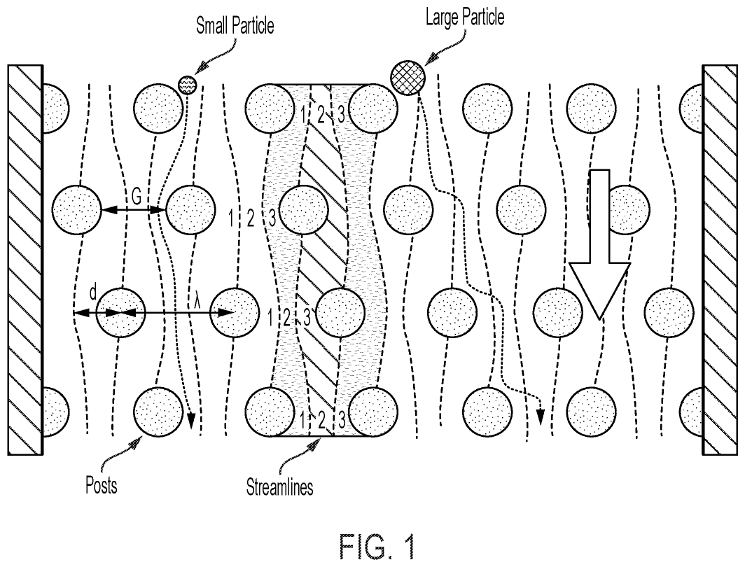

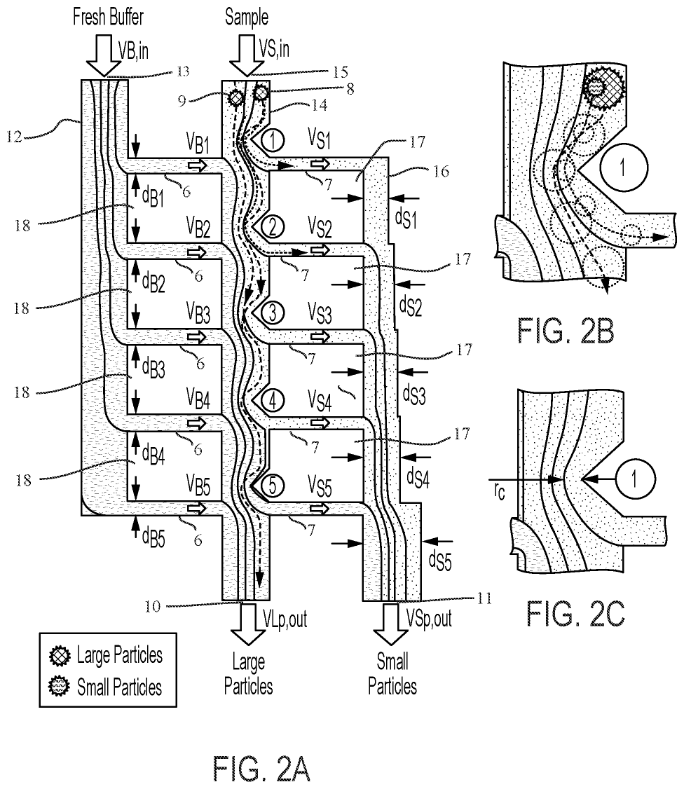

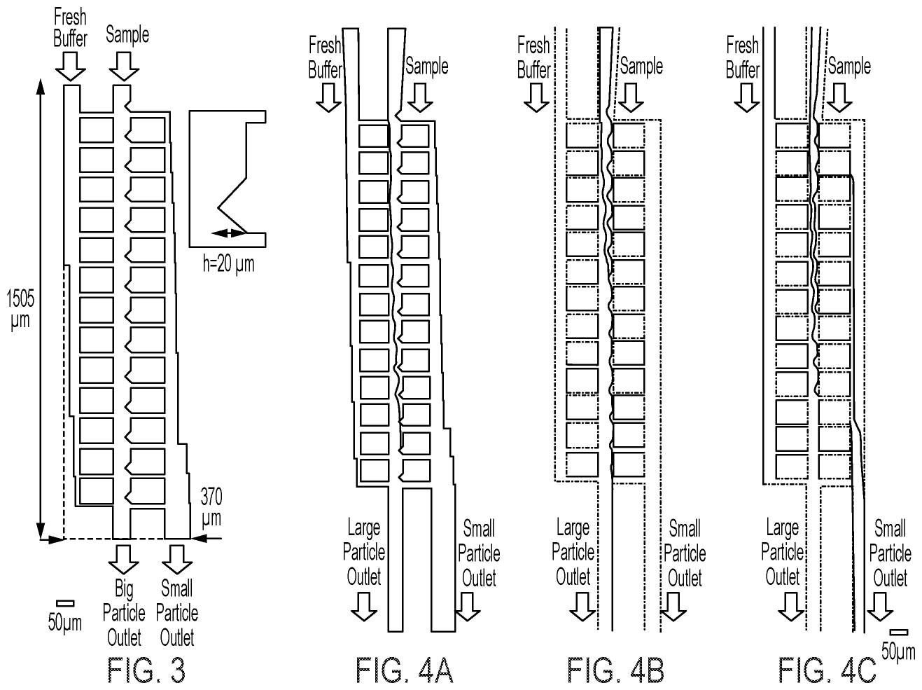

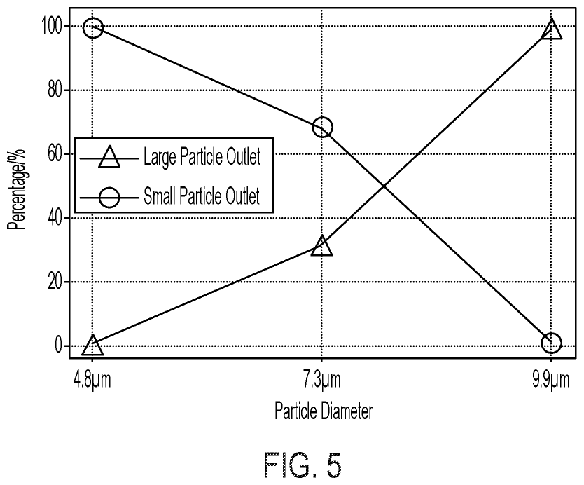

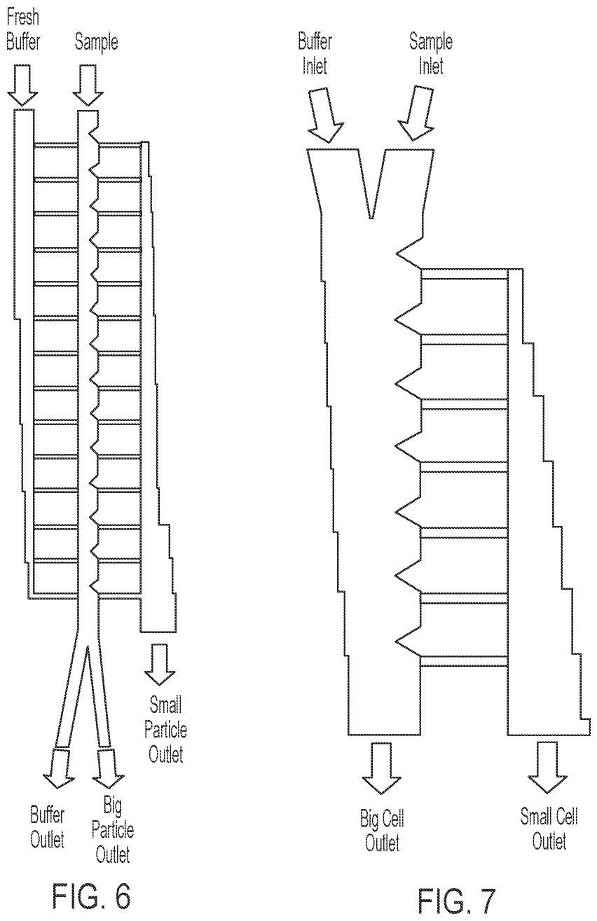

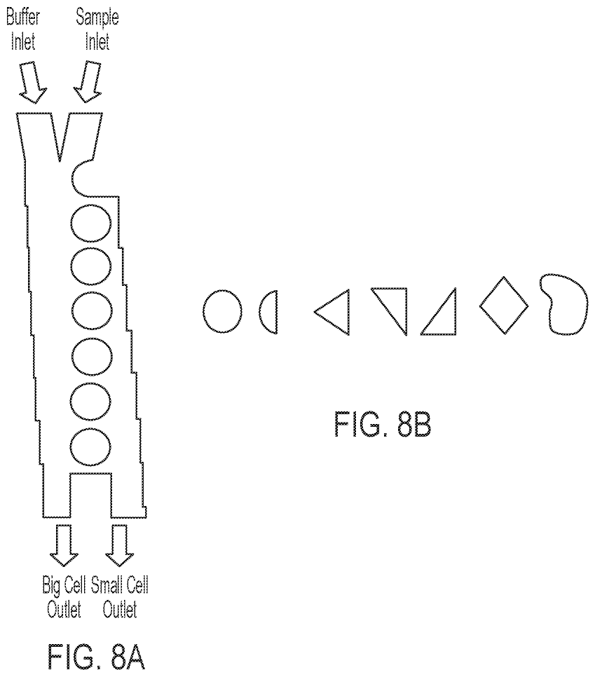

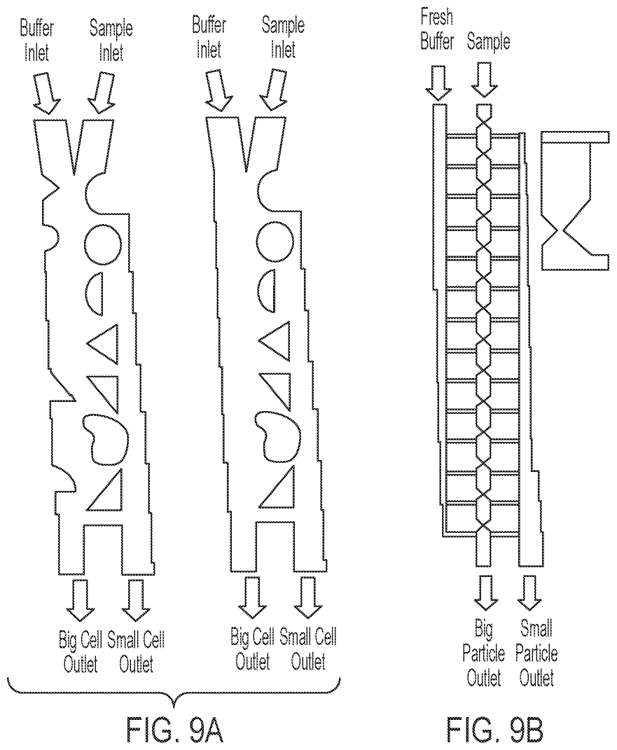

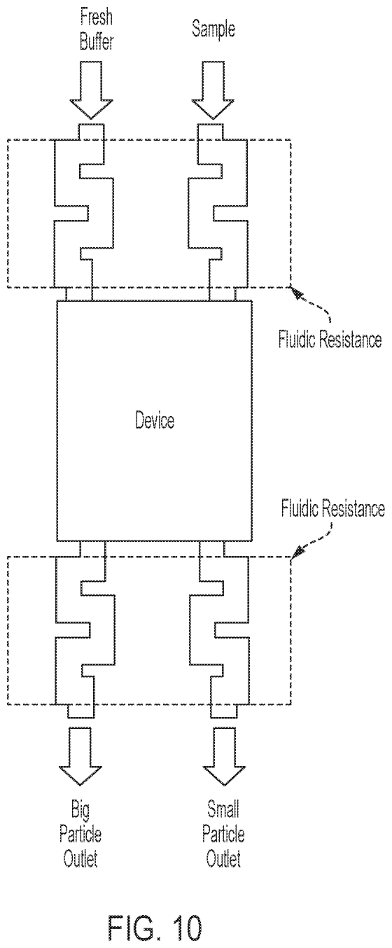

In order to separate particles based on flow segmentation, DLD can be used. In a conventional DLD device, a particle-containing fluid, confined by walls, flows vertically through an array of posts, whose vertical axis is “tilted” with respect to the macroscopic average flow direction (FIG. 1). A small particle flows along a stream-tube towards a small-particle collection outlet, while a particle larger than a critical diameter “bumps” off successive posts from one streamtube to an adjacent one, a process that repeats at each row. It ends up in a “large-particle” collection outlet at the bottom right of the device.

The critical diameter of a conventional DLD array depends on the width of the streamtube adjacent to the bumping surface, and can be experimentally adjusted by the gap size G between the posts, and tilt angle “e”. A bulk array with posts and mirrored layout benefits from the uniform flow within the array (except for the boundaries). This conventional design has been widely used for particles and cells sorting from 100 nm to 30 nm because of its stable performance.

However, the conventional design suffers from low throughput per area. Large particles migrate towards the collection outlet after bumping through 1/e rows of posts for each column of obstacles it has to cross (a “unit cell”). A typical epsilon of 1/20, implies 20 rows per column. To collect the particles that enter the top of the array far from the large particle collection outlet on the bottom right, crossing many columns, many rows are required. Further, at least half (the bottom left half) of the entire DLD array is “idle” since no large particles are bumping within this region.

### Example 2: A Single-Column DLD Device

Introduction and Principles of Operation

A new approach to shrink the DLD, while maintaining its fundamental concept of large particles repeatedly bumping off multiple rows of obstacles, consists of only one column of bumping obstacles. FIG. 2A shows such a schematic. The mechanism of size-based particle separation is the same as the conventional DLD array, but the lateral displacement of particles, colloquially referred to as “bumping,” only occurs in the central column. While bumping is a complex process, for the purposes of illustration we assume a particle follows the streamtube where its center lies, and that the particle is a rigid sphere. As in the conventional DLD, small particles follow the fluid flow, hence coming out at the bottom right VB,ᵢₙ.

Note that in the central column, at each row an obstacle to flow protrudes into the column from the right (FIG. 2B). When the streamtube adjacent to the right wall becomes narrow near an obstacle (FIG. 2B), a particle larger than a critical diameter can no longer “fit” into the streamtube adjacent the obstacle wall, and “bumps” off the wall so that its center falls into the adjacent streamtube (FIG. 2C). The large particle then follows the path of the new streamtube. Due to fluid from the central channel exiting to the small particle outlet channel, at the next bumping point, this new streamtube becomes the one adjacent to the bumping point, and the process of FIG. 2B repeats. Thus, large particles remain in the central channel to leave in the “large particle” outlet and small one leaves. Thus, the device is analogous to the conventional deterministic lateral displacement device of FIG. 1. However, the present device has only one particle-carrying channel in the vertical dimension, and only one “unit cell” of rows, leading to its extremely small size. After the final bump, all the original buffer exits the middle channel which indicates the complete replacement of buffer and depletion of small particles from the middle channel. (In the schematic of FIG. 2A, small and large particles should already be completely separated after the fourth obstacle, so the fifth is there only for a “safety factor”).

The critical diameter determining which particles bump can be quantitatively determined by the distance from the post and the streamline that determines the flow segmentation (see FIGS. 2B and 2C). The critical diameter dc in FIG. 2B can be estimated by d_{c}=2r_{c}, where r_{c} is the distance from the post and the streamline that determines the flow segmentation.

Instead of tuning the segmentation of flow and thus critical particle size by tilt angle (ε=d/λ) and gap size (G) as in a conventional DLD array, one may adjust the ratio of the width of small-particle collection outlet channels (d_{S1} to d_{S5}) to the width of fresh buffer input channels (d_{B1} to d_{B5}). A bigger d_{S1} allows a larger portion of fluid flows into the small-particle collection outlets and thus increases the critical diameter.

Ideally, the critical bumping size is the same in each row. The current design used identical flow patterns at each obstacle. Since a portion of the sample containing-fluid exits the main channel at each row, a certain amount of fresh buffer needs to be injected to maintain the proper flow pattern. A proper design of width of fresh buffer input channels (d_{B1} to d_{B5}) ensures that the volumetric flow rate of fresh buffer injected in the particle-carrying channel (V_{Bi}, where i∈[1,5]) are same as the amount that flows into the small particle channel V_{Si}, where i∈[1,5]). In this example, for simple operation, we set VB,ᵢₙ equal to the sample input flow rate VS,ᵢₙ. Therefore, on the output end, the volumetric flow rate of the output containing large particles (i.e. above the critical size), VL_{P,out}, is equal that for small particles VS_{P,out}.

Materials and Methods

Device Design

A single column DLD device was designed with a critical diameter of 8 μm. It consisted of 14 bumping points (analogous to rows in a conventional device). The width of the middle channel was 50 μm, the height of each triangle bump (FIG. 3) was 20 μm, and the width of the small channels which connect the center channel to the small particle collection output was 15 μm. The total width of the design (not including the inlet/outlet ports) was 369 μm, and the total length was 1505 μm. The channel depth was 12 μm over the entire device. The width of the small particle collection outlet (d_{Si}) and the fresh buffer inlet channels (d_{Bi}) were designed with 2-D numerical simulation of the flow patterns using MATLAB and COMSOL Multiphysics 5.3. Using the simple criteria for bumping as illustrated in FIG. 2A and described above, the device was designed to have a critical bead diameter of 8.0 μm.

Device Fabrication and Operation

The device was fabricated in silicon wafer using standard microfabrication techniques. Deep Reactive Ion Etching (DRIE) was used to etch the channel. Etching mask was formed on the silicon wafer using standard photolithography (Heidelberg DWL 66+) with AZ1505 photoresist (AZ Electronic Materials, USA) and AZ 300 MIF developer. A SAMCO RIE800iPB reactive ion etcher was used to perform a 12-μm deep etching. Inlets and outlets were 300 μm through-wafer holes created by laser drill. The device was sealed with 3M 9795R polyolefin sealing tape. The device was mounted to a polycarbonate jig with stainless steel ports. Two syringe pumps (Fusion 100T) were used for injection of buffer and samples.

Single-Column DLD Device Sample Preparation and Assessment of Fluid Flow

To evaluate the efficacy of the single-column DLD device in separating microparticles and confirm basic fluid flow, an inverted microscope (Nikon Eclipse TE2000-5) was used to image the movement of particles and flow pattern within the device with a blue-LED light (as the excitation source) with a fluorescence filter set (FITC, 467-498 nm excitation, 513-556 nm emission). Images and movies were captured with a 4× Nikon Plan Fluor objective (0.13 NA and 1.2 mm WD)/10× Nikon Plan objective (0.25 NA and 10.5 mm WD) using a Cannon camera (Cannon Eos 5D) and DSLR Remote Pro software by Breeze Systems.

The device was flushed with 0.2% Pluronic F108 surfactant in DI water for 5 minutes. The buffer and sample were injected into the chips by two syringe pumps at 30μ/min and two centrifuge tubes were used to collect the waste and the product. Finally, a hemocytometer (SKC, Inc. C-Chip Disposable hemocytometers) was used to count the particles in the product and the waste and calculate the recovery rate (particles in the product divided by the sum of particles in the product and waste).

Preparation of Experimental Samples

The fluorescent particles (Thermo Scientific™ Fluoro-Max Dye Green Aqueous Fluorescent Polymer Microsphere, 9.9 μm, 10 mL; Thermo Scientific™ Fluoro-Max Dye Green Aqueous Fluorescent Polymer Microsphere, 4.8 μm, 10 mL; Bang Laboratories, Inc. Green Fluorescent Polymer Particles, 7.32 μm, 1 mL; Duke Standards Green Fluorescent Polymer Microsphere, 0.088 μm, 15 mL) are diluted in 0.2% Pluronic F108 surfactant in DI water (particle concentration 1500 to 5000 microparticles per microliter for 9.9 μm/7.32 μm/4.8 μm microparticles; more than 10000 particles per microliters for 0.088 μm microparticles).

Results and Discussion

To confirm the basic fluid flows in the device, in a first experiment the buffer input and the particle input flows were spiked separately one at a time (without large beads) with 0.088 μm fluorescent polystyrene microparticles. The small size insures that bumping effects on the particles are negligible. They have an estimated diffusion coefficient of 3×10⁻¹² m²/s by Stokes-Einstein Equation. Given flow rates of 30 μL/min (corresponding to a flow speed of approximate 1 m/s) and a device length of 1.5 mm, the estimated diffusion length of the particles during their time in the device was approximately 0.05 μm. Because this is much smaller than the widths of the channels in the device, the fluorescence of the particles should be a good marker of the fluid flows. FIG. 4A is a false-color overlay of 2 images, one with the sample input spiked with the fluorescent microparticles and one with the buffer input spiked with the microparticles. The image of FIG. 4A confirms the flow patterns described in the device description of FIG. 2. At the top of the device the flow in the central channel consists entirely of the sample input, but by the end of the device it has been entirely replaced with the buffer input.

Single-Column DLD Device for Sample Polystyrene Bead Separation

The device was tested with fluorescent polystyrene beads in the input, with diameters of 4.8 μm and 9.9 μm. The bead density was in the order of 1000 particles per micro liter. The flow rates of the sample input (containing the beads) and the buffer input were both set at 30 μL/s by syringe pumps. FIGS. 4B and 4C are time lapse fluorescent images of the movement of beads in the device with diameters of 4.8 μm and 9.9 μm, respectively. Over the exposure time of 0.03 s, approximately 20 particles flowed through the device. FIGS. 4A and 4B clearly show that this single-column DLD can separate the 4.8 μm and 9.9 μm particles, as expected based on the designed critical size of 8.0 μm. (The particles used in the experiments emitted green fluorescence under excitation and the blue color of 9.9 μm particles is pseudocolor.)

Note that the particles cover the complete width of the sample input channel to the device. Unlike some particle separation methods, no pre-focusing of the particles to the center of the input channel (or elsewhere) is required. This contributes to device simplicity and removes restrictions on input flow rate, for example. FIG. 5 summarizes the separation ability of the device for input particles with diameters of 4.8 μm, 7.3 μm, and 9.9 μm. The flow rates of the buffer input and of the sample (particle-containing) input were both 30 μL/min. A sample volume of 300 μL was processed in 10 minutes. The single-column DLD device sent 99.9% of the 9.9 μm microparticles to the large particle output, and only 0.2% of the 4.8 μm beads. Conversely the small particle output had 99.9% of the 4.8 μm beads and only 0.2% of the 9.9 μm beads. For 7.3 μm particles, the device sent 32% of the particles microparticles to the large and 68% to the small particle output. Since 7.3 μm is very close to the designed critical diameter of 8 μm, the partial separation of such 7.3 μm particles is expected. The percentage of particles in the large particle outlet/small particle outlet is calculated by dividing the number of particles in the large particle outlet/small particle outlet by sum of the number of particles in the large and small particle outlets.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A deterministic lateral displacement (DLD) device comprising a central channel and a single column of bumping obstacles configured for lateral displacement of particles in the central channel, wherein small particles flow out of the central channel to a small particle channel and large particles stay in the central channel and flow to a large particle outlet.

2. The DLD device of claim 1, wherein the bumping obstacles comprise vertices that protrude into the central channel.

3. The DLD device of claim 1, wherein at least one of the bumping obstacles is circular, semicircular, rectangular, triangular with top side horizontal, and triangular with bottom side horizontal shape.

4. The DLD device of claim 1, wherein the bumping obstacles can be any combination of shape, size, and location within the central channel.

5. The DLD device of any one of claims 1-4, wherein the single column of bumping obstacles has at least four bumping obstacles.

6. The DLD device of any one of claims 1-5, further comprising a buffer channel.

7. The DLD device of any one of claims 1-6, wherein the critical diameter is determined by a distance from an obstacle in the column of bumping obstacles to a streamline that determines flow segmentation.

8. The device of claim 6, wherein the ratio of the width of the small-particle outlet to width of buffer channel is adjusted for the critical diameter.

9. The device of claim 8, wherein a critical bumping size is about equal in each row of the column of bumping obstacles.

10. The device of any one of claims 1-9, wherein fluid flows out from the central channel to the small particle channel.

11. The device of claim of any one of claims 1-10, wherein fluid flows into the central channel from the buffer channel.

12. A microfluidic sorting device comprising: a central channel, a small particle channel; a single column of bumping obstacles configured for lateral displacement of particles in the central channel and a plurality of outlets, wherein the central channel, the sample inlet, the small particle channel and the plurality of outlets are fluidically connected.

13. The microfluidic sorting device of claim 12, wherein the sample inlet is in direct fluid connection with the central channel.

14. The microfluidic sorting device of either claim 12 or claim 13, wherein a large particle outlet is in direct fluid connection with the central channel.

15. The microfluidic sorting device of claim 14, wherein the bumping obstacles are located between the central channel and the small particle channel.

16. The microfluidic sorting device of any one of claims 12-15, further comprising a small particle outlet.

17. The microfluidic sorting device of claim 16, wherein the small particle outlet is in fluid connection with the small particle channel.

18. The microfluidic sorting device of any one of claims 12-17, further comprising a single column of structural elements which creates a buffer channel in fluid connection with the central channel.

19. The microfluidic sorting device of claim 18, wherein the single column of structural elements optionally is configured to serve as a second column of bumping obstacles thereby creating a device with a total of two columns of bumping obstacles.

20. The microfluidic sorting device of any one of claims 12-19, further comprising a buffer inlet in fluid connection with the buffer channel.

21. The microfluidic sorting device of any one of claims 12-20, wherein a plurality of bumping obstacles have the same shape.

22. The microfluidic sorting device of any one of claims 12-20, wherein a plurality of bumping obstacles have different shapes.

23. The microfluidic sorting device of claim 21 or 22, wherein the shape or shapes are circular, semicircular, rectangular, triangular with top side horizontal shape, and triangular with bottom side horizontal shape.

24. The microfluidic sorting device of any one of claims 12-23, wherein a plurality of bumping obstacles have the same size.

25. The microfluidic sorting device of any one of claims 12-23, wherein a plurality of bumping obstacles comprises are of different sizes.

26. The microfluidic sorting device of any one of claims 12-25, wherein bumping obstacles are present on the left side of the central channel.

27. The microfluidic sorting device of any one of claims 12-25, wherein bumping obstacles are present on the right side of the central channel.

28. The microfluidic sorting device of claim 19, wherein a plurality of bumping obstacles are present on both the right side and left side of the central channel.

29. The microfluidic sorting device of any one of claims 12-28, wherein the arrangement and type of bumping obstacles determines the critical diameter for the device, and wherein more than about 30% of particles smaller than the critical diameter flow to the small particle outlet and more than about 30% of particles larger than the critical diameter flow into the large particle outlet.

30. The microfluidic sorting device of claim 29, wherein the percent of particles smaller than the critical diameter value that flow to the small particle outlet is greater than 40%.

31. The microfluidic sorting device of claim 29 or 30, wherein the percent of particles greater than the critical diameter that flow to the large particle outlet is greater than 40%.

32. The microfluidic sorting device of any one of claims 29-31, wherein the critical diameter of the device is between about 4.8 microns and about 9.9 microns.

33. The microfluidic sorting device of any one of claims 29-32, wherein at least one bumping obstacle has a sub-critical diameter that contributes to the critical diameter of the device.

34. The microfluidic sorting device of claim 33, wherein the bumping obstacle has a sub-critical diameter between about 4.8 microns and 9.9 microns.

35. The microfluidic sorting device of any one of claims 29-34, wherein a width of any channel, column, inlet, or outlet of the device is adjusted to maintain the critical diameter of the device.

36. The microfluidic sorting device of any one of claims 33-35, wherein the sub-critical diameter of the plurality of bumping features is about equal.

37. The microfluidic sorting device of any one of claims 12-36, wherein the device further comprises a buffer outlet in fluid connection to the main channel.

38. The microfluidic sorting device of claim 37, wherein the buffer outlet is connected to a feature that occludes particles greater than 0.45 microns from entering the buffer outlet.

39. The microfluidic sorting device of any one of claims 12-38, further comprising additional channels in fluid connection to the sample inlet and end or ends of the device in order to create fluidic resistance and buffer the device from pressure fluctuations between the sample inlet and end or ends of the device.

40. The microfluidic sorting device of claim 39, wherein at least one additional channel is in the form of a meandering channel.

41. The microfluidic sorting device of claim 39 or 40, wherein the fluidic resistance is adjusted for the critical diameter of the device.

42. The microfluidic sorting device of any one of claims 12-41, wherein the microfluidic sorting device is fabricated from silicon wafer.

43. The microfluidic sorting device of any one of claims 12-41, wherein the microfluidic sorting device is fabricated from polycarbonate or other plastic.

44. The microfluidic sorting device of any one of claims 12-41, further comprising a syringe pump for injecting samples.

45. The microfluidic sorting device of any one of claims 12-44, further comprising a syringe pump for injecting buffer.

46. The microfluidic sorting device of any one of claims 12-45, wherein the channel area is larger than about 0.30 square millimeters and smaller than about 0.9 square millimeters.

47. A plurality of the microfluidic sorting devices of any one of claims 16-46, wherein the plurality of microfluidic sorting devices are connected in series through fluid connection of their sample inlets.

48. The plurality of the microfluidic sorting device of claim 47, wherein the plurality of microfluidic sorting devices are stacked in such a manner such that the large particle outlet or the small particle outlet from a first device flows into the sample inlet of a second device and so on for the plurality of microfluidic sorting devices.

49. A method of preparing target cells or target particles of a predetermined size from a sample comprising cells or particles of less or more than the predetermined size, the method comprising:
a) applying a sample and a wash fluid to the device of any one of claims 12-48, wherein the wash fluid applied to the device is devoid of said target cells or target particles and devoid of said cells or particles of less or more than the predetermined size;
b) performing deterministic lateral displacement by flowing the sample and wash fluid through the device; and
c) collecting a final product comprising target cells or particles from either the large particle outlet or the small particle outlet.

50. The method of claim 49, wherein the sample comprises eukaryotic cells.

51. The method of claim 50, wherein eukaryotic cells are selected from the group consisting of: white blood cells; stem cells; thrombocytes; synoviocytes; fibroblasts; beta cells; liver cells; megakaryocytes; pancreatic cells; DE3 lysogenized cell; yeast cells; plant cells; algae cells; and combinations thereof.

52. The method of claim 51, wherein the eukaryotic cells are white blood cells.

53. The method of claim 51, wherein the eukaryotic cells are algae cells collected from an algae pond and are dewatered by the method.

54. The method of 52, wherein white blood cells comprise monocytes, T cells, B cells, regulatory T cells, central memory T cells, macrophages, dendritic cells, granulocytes, innate lymphoid cells, natural killer cells, or combinations thereof.

55. The method of any one of claims 49-54, wherein the sample comprises whole blood or cells collected from an apheresis or leukapheresis procedure.

56. The method of any one of claims 49-53, wherein the sample applied to the device is 10-100 times the amount in mass of a sample that could be processed by a DLD device of the same surface area that comprises greater than a single column comprising a plurality of bumping obstacles.

57. The method of any one of claims 49-56, wherein the target cells comprise eukaryotic cells.

58. The method of claim 57, wherein the eukaryotic cells are stem cells, thrombocytes, synoviocytes, fibroblasts, beta cells, liver cells, megakaryocytes, pancreatic cells, DE3 lysogenized cell, yeast cells, plant cells, algae cells, monocytes, T cells, B cells, regulatory T cells, macrophages, dendritic cells, granulocytes, innate lymphoid cells, or natural killer cells.

59. The method of any one of claims 49-58, further comprising genetically engineering the target cells.

60. The method of any one of claims 49-59, further comprising activating cells after collection, wherein activation comprises contacting the final product with a protein or antibody.

61. The method of any one of claims 49-60, wherein output from the large particle outlet or from the small particle outlet is recirculated through the device one or more times.

62. The method of any one of claims 49-61, wherein the wash fluid is water or an aqueous buffer.

63. The method of 62, wherein the wash fluid further comprises:
a) reagents that chemically react with the sample or other components of the wash fluid; or
b) antibodies, carriers, or activators that interact with specific target cells or target particles.

64. The method of any one of claims 49-63, wherein said method is used for producing CAR-T cells.

65. The method of 64, wherein said method is used to concentrate cells sufficiently to allow for their administration to a patient without the need for centrifugation.

66. The method of any one of claims 49-65, wherein the flow rate of the device is greater than about 30 microliters per minute.

67. The method of any one of claims 49-66, wherein the throughput per area of the device is about 54 microliters per minute per millimeter squared.

68. The method of any one of claims 49-67, wherein the target cells or target particles make up at least 5% of the total cells or total particles in the final product.

69. The method of 68, wherein the target cells or target particles make up at least 70% of the total particles in the final product.

70. A microfluidic device for separating particles based on their size, comprising:
a) a central channel connected to a sample inlet at one end and to a large particle outlet located distally to, and fluidically connected with, the sample inlet;
b) a buffer channel connected to a buffer inlet wherein the buffer channel is fluidically connected to the central channel by one or more laterally oriented buffer conduits;
c) a small particle channel fluidically connected to the central channel by one or more laterally oriented sample fluid conduits and fluidically connected to a small particle outlet;
d) a single column of bumping obstacles located between the central channel and small particle channel.

71. The microfluidic device of claim 70 wherein the bumping obstacles have vertices that protrude into the central channel.

72. The microfluidic device of claim 70, wherein there are at least 4 bumping obstacles.

73. The microfluidic device of claim 70, where there are at least 8 bumping obstacles.

74. The microfluidic device of claim 70, where there are at least 12 bumping obstacles.

75. The microfluidic device of any one of claims 70-73, wherein the bumping obstacles are in the shape of triangles, diamonds or other polygons.

76. The microfluidic device of any one of claims 70-75, wherein, during operation:
a) buffer flows into the buffer channel through the buffer inlet, and toward the opposite end of the buffer channel;
b) a portion of the buffer flowing through the buffer channel flows through each laterally oriented buffer conduit and into the central channel;
c) concurrently, sample flows into the central channel through the sample inlet and toward the large particle outlet at the opposite end of the central channel; wherein:
i) the microfluidic device has a critical size and the sample comprises particles larger than the critical size and particles smaller than the critical size;
ii) as they flow through the central channel, the majority of particles smaller than the critical size flow through the laterally oriented sample fluid conduits into the small particle channel and then to the small particle outlet where they are optionally collected as a product enriched in particles smaller than the critical size of the microfluidic device;
iii) as they progress toward the large particle outlet, the majority of particles larger than the critical size are bumped by obstacles away from the laterally oriented sample fluid conduits so that they remain in the central channel and flow to the large particle outlet where they may be collected as a product enriched in cells larger than the critical size of the microfluidic device.

77. A method of separating particles in a sample using the microfluidic device of any one of claims 70-76, wherein the microfluidic device has a critical size and the sample comprises particles that are larger than the critical size and other particles that are smaller than the critical size;
a) flowing the sample through the sample inlet and into the central channel where the particles in the sample flow in the direction of a large particle outlet;
b) concurrently flowing buffer through the buffer inlet where it flows into the buffer channel in a direction away from the buffer inlet and wherein a portion of the buffer flowing in the buffer channel enters into the one or more laterally oriented buffer conduits and into the central channel;
c) collecting fluid flowing through the large particle outlet as a product enriched in particles larger than the critical size of the microfluidic device and/or collecting fluid flowing through the small particle outlet as a product enriched in particles smaller than the critical size of the microfluidic device and/or transporting fluid from the large particle outlet or the small particle outlet through a fluid transfer conduit to another site;
wherein, during operation:
i) the majority of particles in the central channel that are smaller than the critical size of the microfluidic device flow through the laterally oriented sample fluid conduits into the small particle channel and to the small particle outlet; and
ii) the majority of cells larger than the critical size of the microfluidic device are bumped by the bumping obstacles in the central channel thereby preventing them from entering the laterally oriented sample fluid conduits and causing them to remain in the central channel where they flow to the large particle outlet.

78. The method of claim 77, wherein the particles larger than the critical size of the microfluidic device that have been separated from the particles smaller than the critical size of the microfluidic device are either collected from the large particle outlet or are transported through a conduit to another separation device, or instrument or site where they are further purified, analyzed, reacted, structurally altered, genetically engineered, stored, or packaged.

79. The method of claim 77 or 78 wherein the particles larger than the critical size of the microfluidic device and the particles smaller than the critical size of the microfluidic device are both cells.

80. The method of claim 79, wherein the particles larger than the critical size of the microfluidic device are leukocytes or stem cells.

81. The method of either 79 or 80, wherein the particles smaller than the critical size of the microfluidic device are platelets or erythrocytes.

82. The method of any one of claims 79-81, wherein the particles larger than the critical size of the microfluidic device are T cells.

83. The method of claim 82, wherein the T cells are genetically engineered.

84. The method of claim 83, wherein the T cells are used to make CAR T cells.
